(19) United States
(12) Patent Application Publication
(10) Pub. No.: US 2022/0299843 A1
(43) Pub. Date: Sep. 22, 2022

(54) Protective Lens Cover

(71) Applicant: Curv Brands LLC, Miami, FL (US)

(72) Inventor: Michael Tunney, Mount Prospect, IL (US)

(21) Appl. No.: 17/202,892

(22) Filed: Mar. 16, 2021

(51) Int. Cl. G03B 11/04

(52) U.S. Cl. CPC G03B 11/041

(57) ABSTRACT

A lens protector for an electronic device such as a laptop computer, desktop computer, mobile phone or tablet is provided. The lens blocker includes a decorative head portion, an arm extending below the head portion that includes a lens blocker that can be moved between a first position covering the lens and a second position exposing the lens, and a sectioned mounting body extending below the head portion and behind the arm and lens blocker. The sectioned mounting body can be manipulated to varying shapes so that the lens protector can be mounted and used on electronic deices having different sizes and thicknesses.

### FIELD OF THE INVENTION

The present invention is directed to a protective lens cover that can be mounted to electronic devices having a wide variety of sizes and thicknesses.

### BACKGROUND OF THE INVENTION

In recent years, protective lens covers have been developed for use on mobile electronic devices such as mobile phones and laptops as well as larger electronic devices such as desktop screen monitors. The protective lens covers are useful for blocking the camera lens when the camera is not being used. They not only serve to protect the lens from dust and dirt, but also protect the user from unwanted viewing via the camera. Some of the known protective lens covers are large enough to cover both the camera lens and sensor as desired, and/or to cover multiple camera lenses. The known protective lens covers can typically be removed, or moved via a sliding motion, to expose the camera lens when use of the camera is desired. However, the known protective lens covers are generally limited to the specific electronic devices for which they were designed. For example, protective lens covers designed for use with mobile phones are generally useful only for the mobile phones and not for laptops or desktop monitors. Protective lens covers designed for use with desktop monitors are generally useful only for desktop monitors and with limited flexibility as to the size and thickness of the monitor.

There is a need or desire for a protective lens cover that can be universally adapted for use with a wide variety of electronic devices having varying sizes and thicknesses. There is also a need or desire for such a protective lens cover that is easy to install and use and is easy to adapt to electronic devices of different sizes and thicknesses.

### SUMMARY OF THE INVENTION

The invention is directed to a lens protector that can be adapted for use with a wide variety of electronic devices including without limitation mobile phones, laptops, pads, tablets, and desktop monitors having varying sizes, thicknesses, and shapes. In one embodiment, the lens protector includes the following features:

a head portion;

an arm extending below the head portion, the arm having a proximal end closer to the head portion and a distal end remote from the head portion;

a lens blocker at the distal end of the arm that can be moved between a first position covering a lens of the electronic device and a second position exposing the lens; and

a sectioned mounting body extending below the head portion and behind the arm and lens blocker;

wherein the sectioned mounting body includes a first section closer to the head portion, a second section remote from the head portion, and a first movable hinge between the first section and the second section, the first movable hinge being operable to increase or decrease a distance between the lens blocker and the second section.

In another embodiment, the lens protector includes the following features:

a decorative head portion;

an arm extending below the head portion, the arm having a proximal end closer to the head portion and a distal end remote from the head portion;

a hand or paw at the distal end of the arm that can be moved between a first position covering a lens of the electronic device and a second position exposing the lens; and

a sectioned mounting body extending below the head portion and behind the arm and lens blocker;

wherein the sectioned mounting body includes a shoulder closer to the head portion, a foot remote from the head portion, and a first movable hinge between the shoulder and the foot, the first movable hinge being operable to increase or decrease a distance between the hand or paw and the foot.

In another embodiment, the lens protector includes the following features:

a decorative head portion;

a rotatable arm extending below the head portion, the rotatable arm having a proximal end closer to the head portion and a distal end remote from the head portion;

a lens blocker at the distal end of the rotatable arm that can be moved between a first position covering a lens of the electronic device and a second position exposing the lens by rotating the rotatable arm; and

a sectioned mounting body extending below the head portion and behind the rotatable arm and lens blocker;

wherein the sectioned mounting body includes a first section closer to the head portion, a second section remote from the head portion, and a first movable hinge between the first section and the second section, the first movable hinge being operable to increase or decrease a distance between the lens blocker and the second portion.

The features and advantages of the invention will become further apparent from the following detailed description, read in conjunction with the accompanying drawings.

### BRIEF DESCRIPTION OF THE DRAWINGS

FIG. 1 is s front view of one embodiment of a lens protector of the invention, mounted on a desktop monitor.

FIG. 2 is a side view of the lens protector of FIG. 1.

FIG. 3 is a side view of another embodiment of a lens protector of the invention. mounted to a desktop monitor.

FIG. 4A is a front view of one embodiment of an intermediate section of a sectioned mounting body useful in the lens protector of the invention.

FIG. 4B is a front view of another embodiment of an intermediate section of a sectioned mounting body useful in the lens protector of the invention.

FIG. 4C is a first end view of the intermediate section shown in FIG. 4B.

FIG. 4D is a second end view of the intermediate section shown in FIG. 4B.

FIG. 5 is an end view of one type of hinge useful in the lens protector.

FIG. 6 is an exploded side view of another type of hinge useful in the lens protector.

FIG. 7 is an exploded side view of another type of hinge useful in the lens protector.

FIG. 8 is an exploded side view of another type of hinge useful in the lens protector.

### DETAILED DESCRIPTION OF THE INVENTION

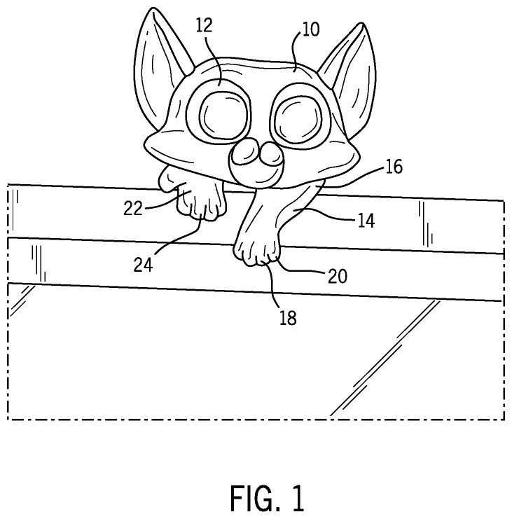

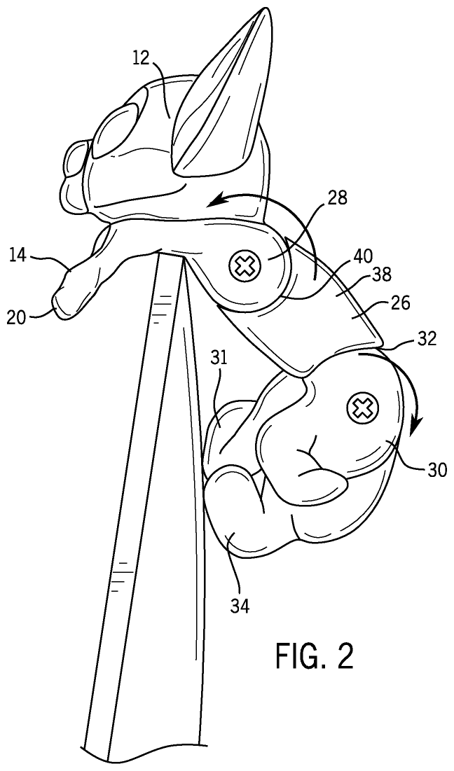

Referring to FIGS. 1-2, a lens protector 10 is provided for an electronic device. The electronic device can be a mobile phone, laptop, pad, tablet, desktop monitor or other similar device and can have any commonly know or contemplated size, shape, and thickness. The lens protector 10 includes a head portion 12 which, when the lens protector 10 is mounted, typically stands above the electronic device 10. The head portion 12 can be a decorative head portion as shown. Examples of decorative head portions include without limitation those resembling the heads of animals, humans, cartoon characters, fictional and make-believe characters, and the like.

The lens protector 10 also includes an arm 14 extending below the head portion 12 which, when the lens protector 10 is mounted, extends downward over the front side of the electronic device. The arm 14 includes a proximal end 16 closer to the head portion 12 and a distal end 18 remote from the head portion 12. A lens blocker 20 is located at the distal end 18 of the arm 14. The lens blocker 12 can have any size or shape. In a decorative embodiment, for example, the lens blocker 12 can resemble a hand or paw. The lens blocker 20 can be moved between a first position covering a lens of the electronic device and a second position exposing the lens of the electronic device. The moving of the lens blocker 20 can be accomplished by sliding the lens blocker 10 to the left or right from its mounting position on the electronic device, or by dismounting the lens protector 10 from the electronic device. In another embodiment, the arm 14 and/or the head 10 can be made rotatable in a clockwise or counter-clockwise direction so that the lens blocker 20 can be moved between the first position and the second position without sliding the lens protector 10 to the left or right or dismounting the lens blocker 10. In this latter embodiment, the lens protector 10 can be more securely mounted to the electronic device and can be permanently affixed, if desired.

In one embodiment, the lens protector 10 can also include a second arm 22 for aiding in the mounting of the lens protector 10 to the electronic device. In this embodiment, the second arm 22 can also extend below the head portion 12 and somewhat downward over the front of the electronic device. In one embodiment, the second arm 22 can also include a mounting element 24 at its distal end. In decorative embodiments, the mounting element 24 can resemble a hand or paw or can have another decorative configuration.

As shown in FIG. 2, the lens protector 10 also includes a sectioned mounting body 26 that extends below the head portion 12 and behind the arm 14 and lens blocker 20. When the lens protector 10 is mounted to an electronic device, the sectioned mounting body 26 extends downward over the back side of the electronic device as shown in FIG. 2. The sectioned mounting body 26 includes a first section 28 that is closer to the head portion 10 and can be adjacent to the head portion 10, a second section 30 that is remote from the head portion 10, and a movable hinge 32 between the first section 28 and the second section 30. The second section 30 has a distal end 34 that can engage a backside of the electronic device for secure mounting. In one embodiment, when the lens protector 10 is mounted to the electronic device, the lens blocker 20 at the distal end 18 of the arm 14 engages or is very close to the front side of the electronic device while the distal end 34 of the second section 30 of the mounting body 26 engages the back side of the electronic device. In one decorative embodiment, the distal end 34 of the second section 30 can be configured as a foot, hoof, or shoe of a human or animal, or can have another decorative design. The second section 30 can also have a branched configuration with two distal ends 34 and 36 as shown in FIG. 2, whereupon both distal ends engage the backside of the electronic device simultaneously during mounting to provide additional support. In a decorative embodiment, both distal ends 34 and 36 can be configures as feet, hooves, shoes, or another decorative design.

The movable hinge 32 is configured and operable to increase or decrease a distance between the lens blocker 20 and the second section 30 of the mounting body 26. The distance can be defined as a straight line between any suitable point on the lens blocker 20 and any suitable point on the second section 30 and can be a straight line between the lens blocker 20 and the distal end 34 of the second section 30. By using the movable hinge to increase or decrease a distance between the lens blocker 20 and the second section 30 of the mounting body 26, the lens protector 10 can be adapted for use on a wide variety of electronic devices having different sizes and thicknesses. The electronic devices can range in size from mobile phones to desktop computer monitors having different sizes and can include laptops, tablets, notepads, and other electronic devices equipped with camera lens and sensor.

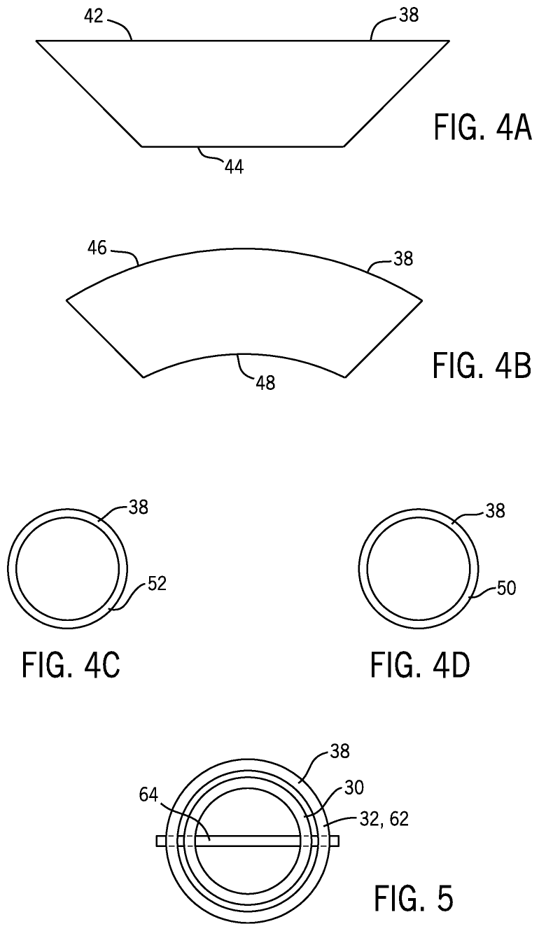

In one embodiment, as shown in FIG. 2, the sectioned mounting body 26 includes an intermediate section 38 between the first and second sections 28 and 30. In this embodiment, the first movable hinge 32 can be located between the intermediate section 38 and the second section 30 and a second movable hinge 40 can be located between the intermediate section 38 and the first section 28. In one embodiment, the first and second movable hinges 32 and 40 can be rotating hinges, whereupon the second movable hinge 40 enables rotation of the intermediate section 38 relative to the first section 28 and the first moveable hinge 32 enables rotation of the intermediate section 38 relative to the second section 30. In one embodiment, the intermediate section 38 can be cylindrical or frustoconical and can be asymmetric as shown in FIG. 4A so that a first longitudinal side 42 has a first length, a second longitudinal side 44 has a second length, and the first length is greater than the second length. The intermediate section can also be curved as shown in FIG. 4B, with the respective first longitudinal side 46 having a curved first length equal to or greater than a respective curved second length of the second side 48. Referring again to FIG. 2, the configurations of either FIG. 4A or 4B enable the intermediate section 38 to be rotated relative to the first and second sections 28 and 30 so as to increase or decrease a straight line distance between the lens blocker 20 and the distal ends 36 and 38 of the second section 30. Depending on the amount of variation desired, the first length of the first side 42 or 46 can be at least about 10% greater, or at least about 25% greater, or at least about 50% greater, or at least about 100% greater than the second length of the respective second side 44 or 48.

In order for the first and second movable hinges 32 and 40 to function as rotatable hinges, it is desirable for the intermediate section 38 to have a first circular cross-section 50 in the vicinity of the first movable hinge 32 and a second circular cross-section 52 in the vicinity of the second movable hinge 40 as shown in FIGS. 4C and 4D. Similarly, the mating portion of the first section 28 should have a circular cross-section in the vicinity of the second movable hinge 40 and the mating portion of the second section 30 should have a circular cross-section in the vicinity of the first movable hinge 32. In the embodiment having only one movable hinge 32, both the first section 28 and the second section 30 can have circular cross-sections in the vicinity of the first movable hinge 32.

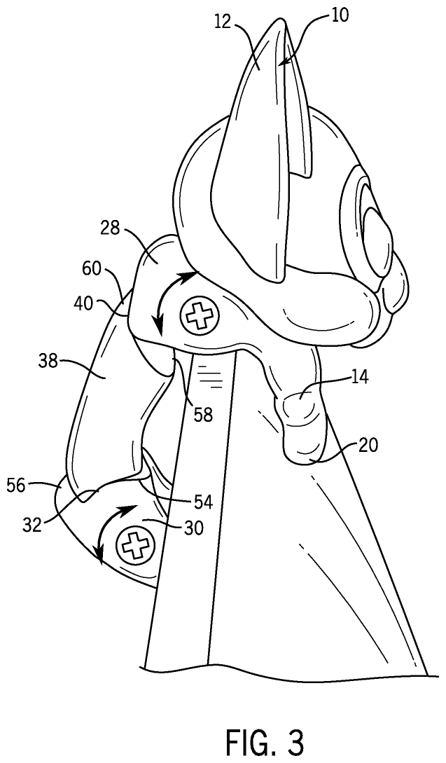

In one embodiment, the lens protector 10 is formed of a flexible material, such as a flexible plastic or rubber material. In another embodiment, the lens protector 10 can be formed of a rigid or semi-rigid material, such an inflexible plastic, in order to facilitate a more secure mounting to the electronic device. FIG. 3 illustrates an embodiment in which the lens protector 10 is formed of a flexible plastic or rubber material and has a hollow interior. In this embodiment, the first movable hinge 32 includes a first cut 54 that extends partially through a thickness of the mounting body 26 between the intermediate section 38 and the second section 30 and a first flexible joined portion 56 adjacent to the first cut 54 and extending through a remainder of the thickness of the mounting body 26. The second movable hinge 40 includes a second cut 58 that extend partially through a thickness of the mounting body 26 between the intermediate section 38 and the first section 28 and a second joined portion 60 adjacent to the second cut 58 and extending through a remainder of the thickness of the mounting body 26. The first and second cuts 54 and 58 can extend through about 25% to about 90% of the thickness of the mounting body 26 at their respective locations, or through about 50% to about 85% of the thickness of the mounting body 26, or through about 60% to about 80% of the thickness of the mounting body 26. The first and second movable hinges 32 and 40 operate by bending the sectioned mounting body 26 sufficiently to open the cuts 54 and 58 by the desired amount so that the distal end of the second section 30 abuts against the back side of the electronic device. In another embodiment, the intermediate section 38 can be omitted so that only the first movable hinge 32, as described, is located between the first and second sections 28 and 30 of the sectioned mounting body 26.

FIGS. 5, 6, 7 and 8 illustrate examples of hinges that can be used for the first movable hinge 32 and/or the second movable hinge 40 in the lens protector of FIG. 2. FIG. 5 illustrates a single-shaft rolling hinge 62 that can be employed in either the single-hinge or double hinge embodiments described above (i.e., wherein the mounting body 26 does or does not include the intermediate section 38 in addition to first and second sections 28 and 30). Rolling hinge 62 includes a shaft 64 mounted in adjoining ends of any two adjacent sections of the sectioned mounting body 26. For example, the adjacent ends of the intermediate section 38 and the second section 30 may overlap in a telescoping fashion as shown in FIGS. 2 and 5. The rolling hinge 62 includes a shaft 64 that is located in the overlapping hollow interior and penetrates both overlapping wall portions of intermediate section 38 and second section 32. Second section 32 can thus be rotated along the shaft 64 in two opposing directions (for example, up or down) relative to intermediate section 38. The first, second and intermediate sections 28, 30 and 38 of the lens protector 10 are desirably hollow to facilitate cost savings on material and the employment of various hinges. The remaining portions of the lens protector 10 can also be made hollow for cost savings, and can be formed of plastic, rubber, or any other suitable material, and can be flexible rigid or semi-rigid as desired.

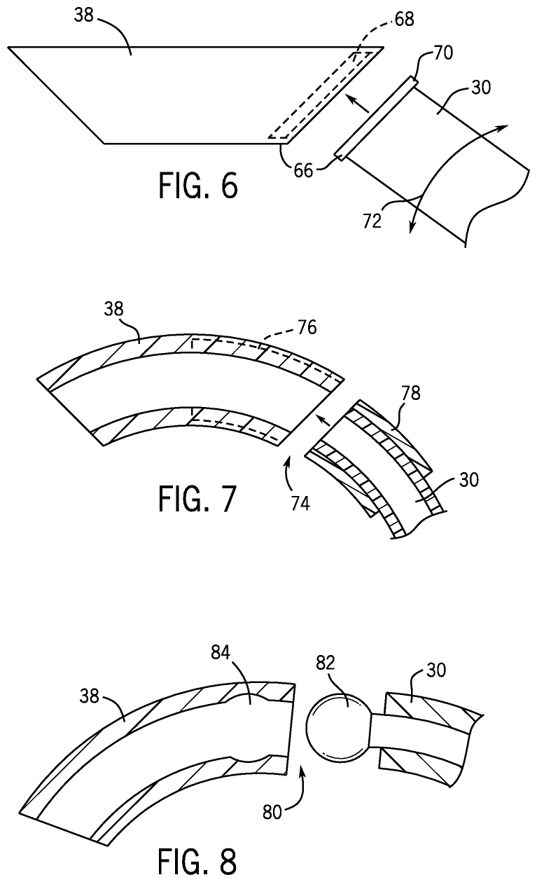

FIG. 6 illustrates an example of a circular rotating hinge 66 that is suitable for use in the double-hinge embodiment of lens protector 10 described above, wherein the mounting body 26 includes the intermediate section 38 in addition to the first and second sections 28 and 30. For best results, a circular rotating hinge 66 can be employed for each of the first and second hinges 32 and 40. As shown in FIG. 6, the adjacent ends of the intermediate section 38 and the second section 30 may overlap in a telescoping fashion as shown in FIGS. 2 and 5. Similarly, the adjacent ends of the intermediate section 38 and the first section 28 may overlap in a telescoping fashion as shown in FIG. 2. The circular rotating hinge 66 is formed by forming a circular female channel 68 along the interior circumference of one of the overlapping sections, such as the intermediate section 38. A corresponding circular male ridge 70 can be formed along the exterior circumference of the other of the overlapping sections, such as the second section 30. Either one of the overlapping sections can be rotated relative to the other in a clockwise or counterclockwise direction by movement of the circular ridge 70 within the circular channel 68, as shown by the arrow 72. In FIG. 6, the intermediate section 38 and the second section 32 are shown as separated in order to better illustrate these features.

FIG. 7 illustrates a sliding hinge 74 which, in the example illustrated, includes a longitudinally oriented female slot 76 in the interior surface of the intermediate section 38 and a corresponding longitudinally oriented male ridge 78 on the exterior surface of the second section 30. The sliding hinge 74 is best suited for an embodiment in which one or both of the adjoining sections of the mounting body 26, for example the intermediate section 38 and the second section 30, have a curved configuration in a lengthwise direction. With this configuration, as the male ridge 78 slides further into the female slot 76, the distal end(s) 34, 36 of the second section 30 move inward and closer to the back side of the electronic device shown in FIG. 2 and the straight-line distance between the lens blocker 20 and the distal end(s) 34, 36 is decreased. As the male ridge 78 is retracted from the female slot 76, the straight-line distance between the lens blocker 20 and the distal end(s) 34, 36 is increased, enabling the lens protector 10 to be mounted on an electronic device having greater thickness.

FIG. 8 illustrates a ball-and-socket hinge 80 that can be used for movement in any direction of any section of the mounting body 26 relative to an adjacent section. In the example shown, a ball 82 protrudes from the proximal end of the second section 30 and mates with a socket 84 formed in the interior wall of the intermediate section 38. The ball-and-socket hinge 80 enables maximum versatility in the construction of the first hinge 32 and/or second hinge 40 because it can be used in either a single-hinge or double-hinge embodiment of the mounting body 26 and can enable movement in any direction of adjacent sections relative to each other.

Referring again to FIG. 1, in one embodiment, the lens protector 10 can be designed so that the arm 14 is rotatable in a clockwise of counter-clockwise direction so that the lens blocker 20 can be moved between the first position covering a lens of the electronic device and a second position exposing the lens without dismounting or sliding the lens protector 10 to the left or right. This can be accomplished in a number of different ways using the types of hinges described above or other hinge types. In one embodiment, the head portion 12 can be made rotatable relative to the mounting body 26 using a circular rotating hinge resembling the hinge 66 described with respect to FIG. 6 or a ball-and-socket hinge resembling the hinge 80 described with respect to FIG. 8. In this embodiment, rotation of the head will cause movement of the arm 14 in a clockwise or counterclockwise direction. In another embodiment, the arm 14 can be made movable relative to the head 12 using a single shaft rolling hinge resembling the hinge 62 described with respect to FIG. 5 or a ball-and-socket hinge resembling the hinge 80 described with respect to FIG. 8. Various other techniques for making the lens blocker 20 movable between the first position and the second position.

The embodiments of the invention described herein are exemplary. Various changes and modifications can be made without departing from the spirit and scope of the invention. The scope of the invention is defined by the appended claims, and all changes that fall within the meaning and range of equivalents are intended to be embraced therein.

I claim:

1. A lens protector for an electronic device, comprising:
a head portion;
an arm extending below the head portion, the arm having a proximal end closer to the head portion and a distal end remote from the head portion;
a lens blocker at the distal end of the arm that can be moved between a first position covering a lens of the electronic device and a second position exposing the lens; and
a sectioned mounting body extending below the head portion and behind the arm and lens blocker;
wherein the sectioned mounting body includes a first section closer to the head portion, a second section remote from the head portion, and a first movable hinge between the first section and the second section, the first movable hinge being operable to increase or decrease a distance between the lens blocker and the second section.

2. The lens protector of claim 1, wherein the sectioned mounting body further comprises an intermediate section between the first section and the second section, and the first movable hinge is located between the intermediate section and one of the first and second sections.

3. The lens protector of claim 2, further comprising a second movable hinge located between the intermediate section and the other of the first and second sections.

4. The lens protector of claim 2, wherein the intermediate section has a first longitudinal side having a first length and a second longitudinal side having a second length, and the first length is greater than the second length.

5. The lens protector of claim 4, wherein the first length is at least about 10% greater than the second length.

6. The lens protector of claim 4, wherein the first length is at least about 25% greater than the second length.

7. The lens protector of claim 4, wherein the first length is at least about 50% greater than the second length.

8. The lens protector of claim 4, wherein the first length is at least about 100% greater than the second length.

9. The lens protector of claim 1, wherein the first section and the second section each have a circular cross-section in the vicinity of the first movable hinge.

10. The lens protector of claim 3, wherein the intermediate section has a first circular cross-section in the vicinity of the first movable hinge and a second circular cross-section in the vicinity of the second movable hinge.

11. The lens protector of claim 1, wherein the first movable hinge is selected from the group consisting of a sliding hinge, a single-shaft rolling hinge, a circular rotating hinge, a ball-and-socket hinge, and combinations thereof.

12. The lens protector of claim 1, wherein the first movable hinge comprises a cut portion that extends partially through a thickness the mounting body between the first and second sections and a flexible joined portion adjacent to the cut portion and extending through a remainder of the thickness of the mounting body.

13. The lens protector of claim 3, wherein the second movable hinge is selected from the group consisting of a sliding hinge, a single-shaft rolling hinge, a circular rotating hinge, a ball hinge, and combinations thereof.

14. The lens protector of claim 3, wherein the second movable hinge comprises a cut portion that extends partially through a thickness the mounting body between the intermediate section and one of the first and second sections and a flexible joined portion adjacent to the cut portion and extending through a remainder of the thickness of the mounting body.

15. A lens protector for an electronic device, comprising:
a decorative head portion;
an arm extending below the head portion, the arm having a proximal end closer to the head portion and a distal end remote from the head portion;
a hand or paw at the distal end of the arm that can be moved between a first position covering a lens of the electronic device and a second position exposing the lens; and
a sectioned mounting body extending below the head portion and behind the arm and lens blocker;
wherein the sectioned mounting body includes a shoulder closer to the head portion, a foot remote from the head portion, and a first movable hinge between the shoulder and the foot, the first movable hinge being operable to increase or decrease a distance between the hand or paw and the foot.

16. The lens protector of claim 15, wherein the sectioned mounting body further comprises a spine between the shoulder and the foot, and the first movable hinge is located between the spine and the shoulder or the foot.

17. The lens protector of claim 16, further comprising a second movable hinge located between the spine and the other of the shoulder and the foot.

18. The lens protector of claim 15, further comprising a front hinge associated with the hand or paw and operable to rotate the hand or paw between the first position and the second position.

19. A lens protector for an electronic device, comprising:
a decorative head portion;
a rotatable arm extending below the head portion, the rotatable arm having a proximal end closer to the head portion and a distal end remote from the head portion;
a lens blocker at the distal end of the rotatable arm that can be moved between a first position covering a lens of the electronic device and a second position exposing the lens by rotating the rotatable arm;
a sectioned mounting body extending below the head portion and behind the rotatable arm and lens blocker;
wherein the sectioned mounting body includes a first section closer to the head portion, a second section remote from the head portion, and a first movable hinge between the first section and the second section, the first movable hinge being operable to increase or decrease a distance between the lens blocker and the second portion.

20. The lens protector of claim 19, wherein the sectioned mounting body further comprises an intermediate section between the first section and the second section, and the first movable hinge is located between the intermediate section and one of the first and second sections.
